(19) United States
(12) Patent Application Publication
(10) Pub. No.: US 2022/0020973 A1
(43) Pub. Date: Jan. 20, 2022

(54) BATTERY SYSTEM WITH CYLINDRICAL CELLS

(71) Applicant: Kitty Hawk Corporation, Palo Alto, CA (US)

(72) Inventors: Derek Wong, Fremont, CA (US); Alexis Shimanoff, Santa Clara, CA (US); Arunanshu Roy, Sunnyvale, CA (US)

(21) Appl. No.: 16/929,534

(22) Filed: Jul. 15, 2020

(51) Int. Cl. H01M 2/10; H01M 2/22; H01M 10/04; H01M 10/42; H01M 10/48; B64D 27/24; B60L 50/64; B60L 58/18

(52) U.S. Cl. CPC H01M 2/1077; H01M 2/22; H01M 10/0422; H01M 10/4257; H01M 10/482; H02J 7/0048; B60L 50/64; B60L 58/18; H01M 2010/4271; H01M 2220/20; B64D 27/24

(57) ABSTRACT

A battery system which includes a plurality of cylindrical cells, including a first cylindrical cell and a second cylindrical cell, an electrical tab that is connected to the first cylindrical cell and the second cylindrical cell using spot welding, and a battery management printed circuit board, where the electrical tab provides a connecting surface for a battery management signal between (1) the first cylindrical cell and the second cylindrical cell and (2) the battery management printed circuit board.

### BACKGROUND OF THE INVENTION

With roads becoming more and more congested, it would be desirable to develop alternative modes of travel, including such as aircraft that are easier and/or simpler to fly. In particular, electric vertical take-off and landing (eVTOL) vehicles are attractive because they do not require long runways and therefore can be deployed in and conveniently accessed in urban environments. Naturally, as such vehicles are prototyped and tested, various parts or components of such vehicles will be improved for better performance.

### BRIEF DESCRIPTION OF THE DRAWINGS

Various embodiments of the invention are disclosed in the following detailed description and the accompanying drawings.

FIG. 1A is a diagram illustrating an embodiment of an electric vertical take-off and landing (eVTOL) vehicle.

FIG. 1B is a diagram illustrating an embodiment of an electric vertical take-off and landing (eVTOL) vehicle with batteries in the float.

FIG. 2 is a diagram illustrating an example of a battery system with pouch cells.

FIG. 3A is a diagram illustrating an embodiment of a battery system with 63 cylindrical cells in an open frame.

FIG. 3B is a diagram illustrating an embodiment of an inward-facing surface of an end plate showing holes to hold cylindrical cells.

FIG. 3C is a diagram illustrating an embodiment of an outward-facing surface of an end plate showing cutouts to provide access to the cylindrical cells.

FIG. 3D is a diagram illustrating an embodiment of 63 cylindrical cells connected in a 3p21s configuration.

FIG. 4 is a diagram illustrating an embodiment of a battery system with 72 cylindrical cells in a case.

FIG. 5A is a diagram illustrating an embodiment of a swappable battery system with a handle and a display.

FIG. 5B is a diagram illustrating an embodiment of insertion of a swappable battery system at a first point in time.

FIG. 5C is a diagram illustrating an embodiment of insertion of a swappable battery system at a second point in time.

FIG. 5D is a diagram illustrating an embodiment of insertion of a swappable battery system at a third point in time from a first view.

FIG. 5E is a diagram illustrating an embodiment of insertion of a swappable battery system at a third point in time from a second view.

FIG. 6 is a diagram illustrating an embodiment of a vehicle with a battery positioned beneath an access panel in a float.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Various embodiments of a new battery system with cylindrical cells are described herein. In some embodiments, the battery system includes a plurality of cylindrical cells, including a first cylindrical cell and a second cylindrical cell, and an electrical tab that is connected to the first cylindrical cell and the second cylindrical cell using spot welding. The battery system also includes a battery management printed circuit board, where the electrical tab provides a connecting surface for a battery management signal between (1) the first cylindrical cell and the second cylindrical cell and (2) the battery management printed circuit board. As will be described in more detail below, the battery system with cylindrical cells described herein was developed as a second generation solution to an existing battery system (without cylindrical cells) used by an ultralight and overwater electric vertical take-off and landing (eVTOL) vehicle. As a result, the battery system with cylindrical cells is required to meet or otherwise have certain characteristics. Before describing the battery system with cylindrical cells it may be helpful to first describe the vehicle that it is used in and developed for.

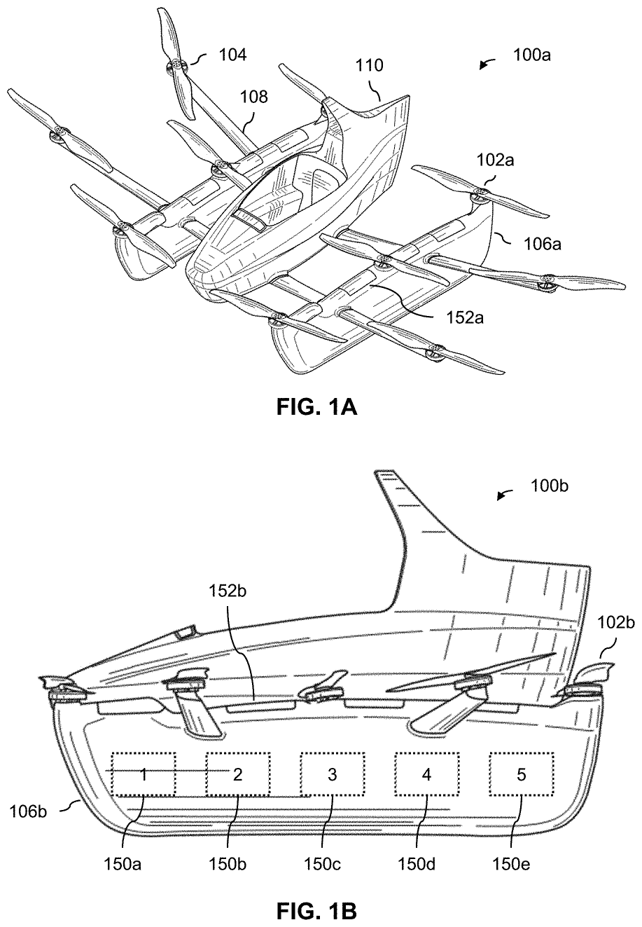

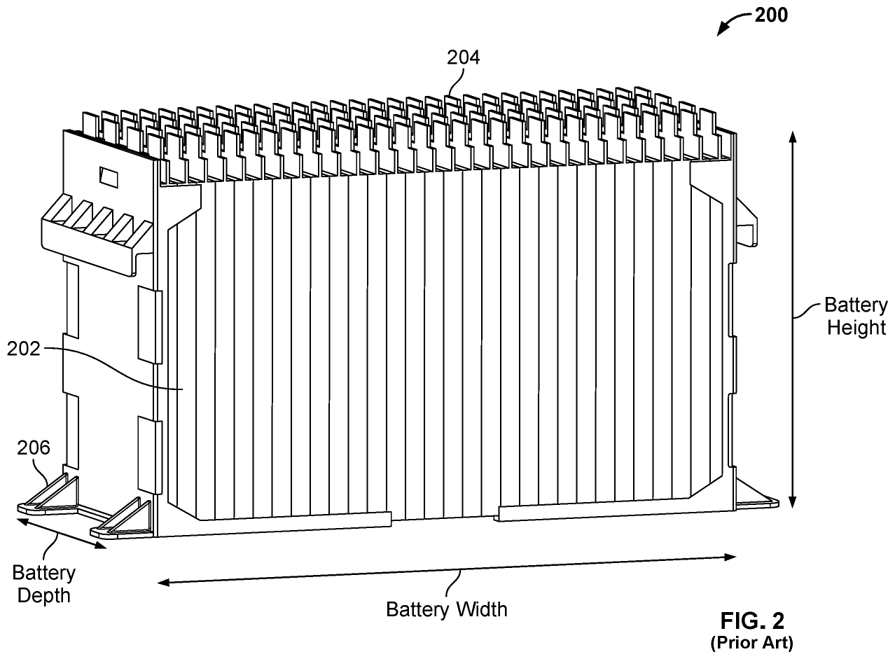

FIG. 1A is a diagram illustrating an embodiment of an electric vertical take-off and landing (eVTOL) vehicle. Although the battery system described herein was developed for and is used in the eVTOL vehicle shown here, this is merely one example of a vehicle that uses the battery embodiment(s) described herein. In this example, the vehicle (100a) is a multicopter with 10 motors (e.g., 102a and 104), each of which is individually and/or independently powered by a corresponding battery (not shown here). Six of the motors are inboard motors (e.g., 102a) which are attached to or otherwise disposed on the top surface of the floats (106a). The remaining four motors are outboard motors (e.g., 104) which are attached to the distal ends of the booms (e.g., 108) which extend outward from the fuselage (110) and through the booms (e.g., 108).

The booms (108) provide a support for the outboard motors (e.g., 104) and also couple or otherwise connect the fuselage (110) and floats (e.g., 106a). They are not, however, wings, and all (or at least almost all) of the vertical lift to keep the vehicle airborne is provided by the motors. As such, motor and battery redundancy and reliability are important design considerations, as is battery weight (e.g., for vehicle range).

For safety, the exemplary vehicle is capable of taking off from and/or landing on water, if desired. To that end, the floats (106a) provide the necessary buoyancy to keep the vehicle afloat on water and permit water takeoffs and/or landing, if desired. For example, in some applications, it may be desirable to restrict the exemplary vehicle to overwater flight since it may be safer for the vehicle to crash in water as opposed to solid ground (e.g., the pilot is more likely to survive a crash over water). To prevent water intrusion into the floats (e.g., 106a), access panels (e.g., 152a) to access batteries and other components inside the floats are located on the top surface of the floats. If desired, the vehicle can alternatively take off from and/or land on land.

FIG. 1B is a diagram illustrating an embodiment of an electric vertical take-off and landing (eVTOL) vehicle with batteries in the float. In this example, each of the 10 motors (e.g., 102b) is individually and/or independently powered by a corresponding battery in the eVTOL vehicle (100b). Each float (e.g., 106b) stores five batteries (150a-150e). To access the batteries and other components inside the floats (e.g., 106b), the floats have three access panels (152b) on the top surface.

The eVTOL vehicle shown is an ultralight, relatively compact aircraft that weighs 250 lbs. without a pilot where the batteries collectively weigh ˜120 lbs. out of that total. The footprint of the vehicle is also relatively small to permit the vehicle to fit into a (standard) trailer (e.g., sideways, boom tips first) with a nose-to-tail length of ˜88 inches. As a result, the batteries (150a-150e) need to similarly be relatively light and relatively compact.

The following figure shows an initial version of the batteries with pouch cells.

FIG. 2 is a diagram illustrating an example of a battery system with pouch cells. Some battery system components (such as the front panel of the case and the lid) which obscure other, more relevant components are not shown in this diagram. In this example, the battery system (200) is an initial version of the battery system in use when the exemplary vehicle (shown in FIGS. 1A and 1B) was initially developed. The battery system shown here (200) includes and is powered by a plurality of pouch cells (202). Flexible tabs (204), some of which are positive tabs and some of which are negative tabs, are used to conduct the electricity generated by the pouch cells out to external connectors. In this example, the tabs (204) are connected to leads or other connectors on the underside of the lid (not shown) where the lid has external positive and negative terminals or connections on the top surface of the lid.

To secure the battery system to the vehicle, the battery system has four feet (206) through which a bolt or other fastener (not shown) is screwed to secure the battery system to a shelf (not shown) in the float which all of the batteries sit on and are secured to.

In this example, a battery has the following dimensions:

TABLE 1
Dimensions of example battery system shown in FIG. 2.

| | Battery Width | Battery Height |
|---|---|---|
| Battery Depth | (Excluding Feet) | (to Top of Case, Excluding Lid) |
| 48.2 mm | 123.5 mm | 147.6 mm |

Batteries that are designed for electric cars tend to have thousands of cells arranged in a single large, high voltage pack (e.g., 350V-600V) to maximize power output despite the relatively high weight (e.g., 1,054 lbs.). In contrast, the batteries described herein (which are designed for electric aircraft) have much lower voltages (e.g., on the order of 100V) designed to have multiple batteries for redundancy and safety (e.g., one battery per motor) instead of a single battery for the entire vehicle. Battery weight is also an important consideration in aircraft applications, and especially for the ultralight eVTOL vehicle described above. The (maximum) power delivery of the electric aircraft batteries described herein is also an important consideration for aircraft and especially for eVTOL vehicles during the power-hungry vertical take-offs and landings.

Electric car batteries also tend to use energy dense cells (e.g., cells with energy densities above 245 Wh/kg) to maximize electric car range but the downside of such cells is that such energy dense cells used limit or otherwise reduce the maximum power output. In contrast, maximum power output is an important consideration for electric aircraft and especially for eVTOL vehicles (e.g., vertical take-offs and landings are very power-hungry operations). In addition, due to the smaller, redundant, and lighter nature of batteries for electric aircraft, cells in electric aircraft batteries are expected to individually contribute a larger percentage of the power load and therefore are capable of high rate discharges.

Finally, electric car batteries tend to have cooling systems designed to keep the battery in some desired temperature range (e.g., 20° C.-40° C.) to maximize the lifetime of the battery. However, these cooling systems add weight and are much more undesirable in aircraft. As such, the aircraft batteries described herein do not operate with a cooler (e.g., the floats of the aircraft described above do not include cooling systems to cool the batteries during flight).

The battery system shown in FIG. 2 achieves these objectives but naturally it would be desirable if that battery system could be further improved upon. The following figures describe various embodiments of battery systems which use cylindrical cells and (further) improve upon the battery system shown here.

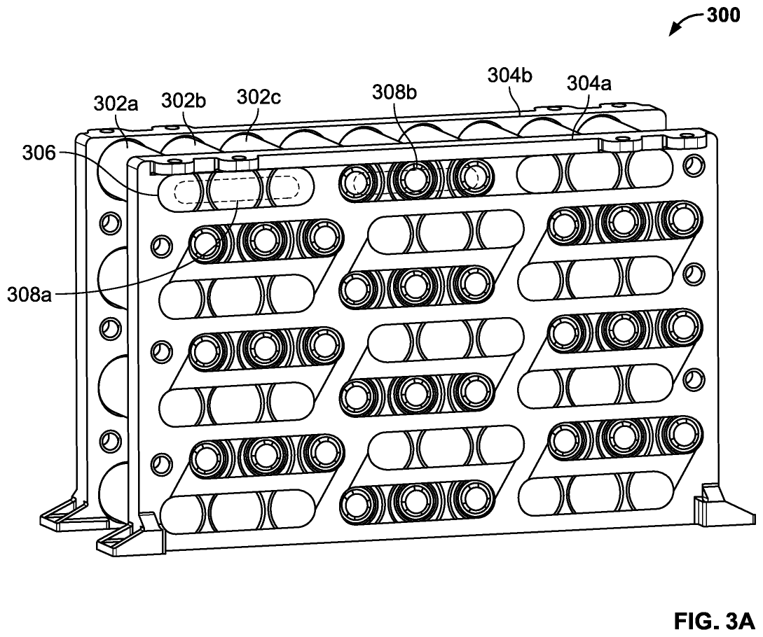

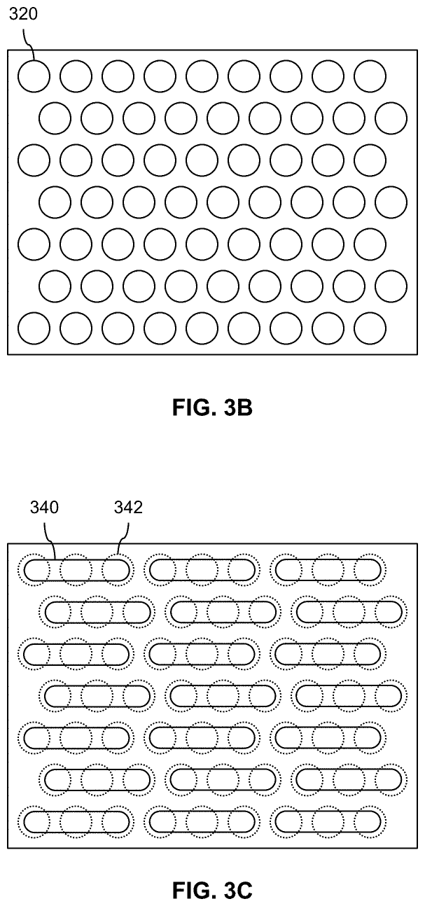

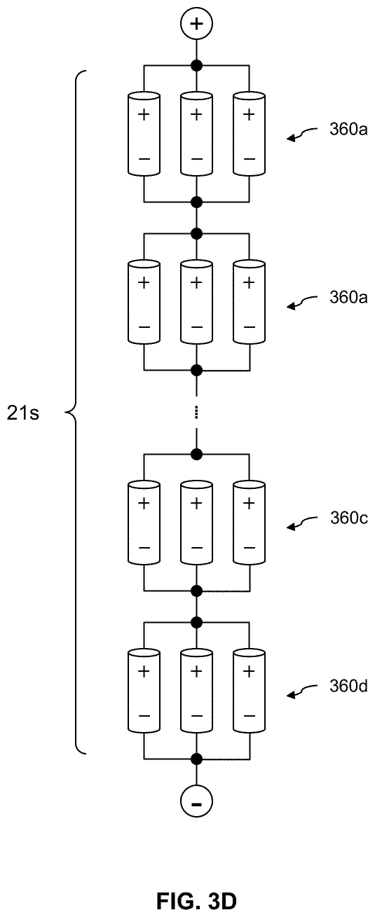

FIG. 3A is a diagram illustrating an embodiment of a battery system with 63 cylindrical cells in an open frame. In the example shown, the battery system (300) is designed to be used in the eVTOL vehicle described in FIG. 1A and FIG. 1B and therefore has (substantially) the same dimensions as the battery system described in FIG. 2 and Table 1. Unlike the battery system described in FIG. 2, however, this battery system (300) includes and is powered by cylindrical cells (e.g., MoliCel P42A cylindrical cell) instead of pouch cells.

TABLE 2
Comparison of pouch cells from FIG.
2 and cylindrical cells from FIG. 3A.

| | Pouch Cells | Cylindrical Cells |
|---|---|---|
| Build Quality | Lower quality | Higher quality |
| External Robustness | Less robust | More robust |
| Weight | +14 g per cell | −14 g per cell |
| Energy Density | 221 Wh/kg | 230 Wh/kg |
| Chemistry | Cobalt based | Nickel based |
| | (less stable) | (more stable) |
| (Dis)charging | Narrower than CC | Wider than PC |
| Temp. Range | | |

As described in Table 2, the cylindrical cells used in battery system 300 have a number of advantages over the pouch cells used in the battery system in FIG. 2. With regards to build quality, the cylindrical cells have better production build quality so there will be fewer cell failures observed in flight.

Also, the pouch cells are less robust (e.g., externally) compared to the cylindrical cells. Whereas cylindrical cells already have a hard, metal cylindrical case which protects cylindrical cells from punctures or other damage, pouch cells are in a flexible or bendable wrapper that can be pierced or otherwise damaged. As a result, pouch cells require additional and/or external protection which in turn increases the total weight of the battery system. And even without taking the additional weight to protect the softer pouch cells into account, each pouch cell weighs 14 g more than each cylindrical cell.

The energy density of cylindrical cells is also higher (i.e., better) than pouch cells at 230 Wh/kg to 221 Wh/kg. In aircraft applications, additional weight reduces range or flight time and so a battery cell with a higher energy density is more desirable.

The nickel-based chemistry of the cylindrical cells also means that cylindrical cells have better stability than pouch cells at high discharge rates and temperatures. In other words, cylindrical cells have a wider charging and discharging operating temperature range compared to pouch cells.

In this example, the battery system (300) includes 63 cylindrical cells (e.g., 302a-302c) which are held in place by an open frame comprising two end plates (304a and 304b). Structurally, the rigid external case of the cylindrical cells is leveraged or otherwise taken advantage of to provide structural support for the battery system as a whole. For example, this exposed frame would not work with cells that are floppy and/or not rigid. In some embodiments, there are no (e.g., additional) structural elements connecting or linking the two end plates beyond the cylindrical cells.

Electrically, the cylindrical cells are arranged or otherwise connected in a 3-in-parallel, 21-in-series (3p21s) arrangement where groups of three cylindrical cells (e.g., 302a-302c) first are electrically connected together in parallel and then the 21 groups of three cylindrical cells are connected together in series.

The two end plates (304a and 304b) include access channels or cutouts (306) which provide access to the positive and negative terminals of the cylindrical cells. An electrical tab (the position of which is indicated by dashed outlines 308a and 308b) fits into the cutouts (e.g., 306) and is connected to the positive or negative terminals of the cylindrical cells using spot welding (at least in this example). To preserve the readability of the drawing, electrical tabs are not shown throughout this drawing. Using spot welding to connect the cylindrical cells to the electrical tab is attractive because it is relatively cheap and simple (e.g., spot welding equipment costs on the order of tens of thousands of dollars). It is also suitable for lower voltage (e.g., low hundreds of volts) and/or a power architecture which uses many smaller batteries (see, e.g., FIG. 1B) instead of a single large battery (e.g., an electric car battery). In contrast, some other types of batteries (e.g., electric car batteries) use wire bonding to make these connections and wire bonding may be unattractive because it costs more (e.g., wire bonding equipment costs on the order of hundreds of thousands of dollars) and/or does not work well with a power architecture which uses many smaller batteries (see, e.g., FIG. 1B) instead of a single large battery (e.g., an electric car battery).

The battery system also includes a battery management printed circuit board (not shown here to preserve the readability of the diagram) where the electrical tab (e.g., 308a and 308b) provides a connecting surface for a battery management signal between cylindrical cells (e.g., 302a-302c) and the battery management printed circuit board. For example, this connection may be monitored and/or used by the battery management system to measure or generate health and/or state information about (as an example) those cylindrical cells (e.g., information specific to a group of three in-parallel cylindrical cells) or all of the cylindrical cells (e.g., as a whole or collectively).

FIG. 3B is a diagram illustrating an embodiment of an inward-facing surface of an end plate showing holes to hold cylindrical cells. This diagram continues the example from above and the inward-facing surfaces of end plates 304a and 304b in FIG. 3A are implemented as shown. As shown in this diagram, the inward-facing surface of the end plate has 63 cylindrical holes (320) which the ends of the cylindrical cells fit into. In some embodiments, an adhesive is inserted into the cylindrical holes (320) to help hold the ends of the cylindrical cells in place in the end plates. As will be shown in more detail below, the entire circular cross section of a battery-holding hole or cutout (320) does not necessarily go all the way through the end plate.

FIG. 3C is a diagram illustrating an embodiment of an outward-facing surface of an end plate showing cutouts to provide access to the cylindrical cells. This diagram continues the example from above and the outward-facing surfaces of end plates 304a and 304b in FIG. 3A are implemented as shown. As described above, the cylindrical cells are grouped in groups of three in parallel cells and so each cutout (e.g., 340) is sized to expose the ends of three cylindrical cells. The cutouts (e.g., 340) provide access to the positive and negative terminals of the cylindrical cells and therefore go entirely through the end plate.

In contrast, the battery-holding holes, which are represented by dashed circles (e.g., 342), have circular cross sections that do not go through the end plate entirely except where they overlap with the cutouts (e.g., 340). This provides a lip or shelf to hold the cylindrical cells in place while still providing access to the positive and negative terminals of the cylindrical cells.

FIG. 3D is a diagram illustrating an embodiment of 63 cylindrical cells connected in a 3p21s configuration. This diagram continues the example from above showing the electrical connection of the cylindrical cells (including 302a-302c) from the battery system (300) shown in FIG. 3A. As described above, the cylindrical cells are first electrically grouped three in parallel (e.g., groups 360a-360d). Then, the groups of three-in-parallel cylindrical cells are connected together in series for 21 groups in parallel. The nominal cell voltage of each cylindrical cell is 3.6V so the voltage produced or otherwise output by the battery system with cylindrical cells in this 3p21s configuration is 75.6 V.

Returning briefly to FIG. 3A, it is noted that the cylindrical cells in each row are oriented so that each group of three alternates direction. For example, from the view shown, electrical tab 308a is connected to the negative terminals of its cylindrical cells while neighboring electrical tab 308b is connected to the positive terminals of its cylindrical cells to form two groups of three in-parallel cells, respectively. To form an in-series connection between the two groups of cells, electrical tabs 308a and 308b are connected together. Similarly, when connecting two electrical tabs in-series between two adjacent rows (e.g., the rightmost group in the top row with the rightmost group in the second-from-top row), opposite polarities are exposed so the wiring to make a serial connection (e.g., between the rightmost group in the top row with the rightmost group in the second-from-top row) is minimized.

The example battery system described in FIGS. 3A-3D is merely exemplary and is not intended to be limiting. For example, the following figure shows another battery system embodiment with 72 cylindrical cells instead of 63.

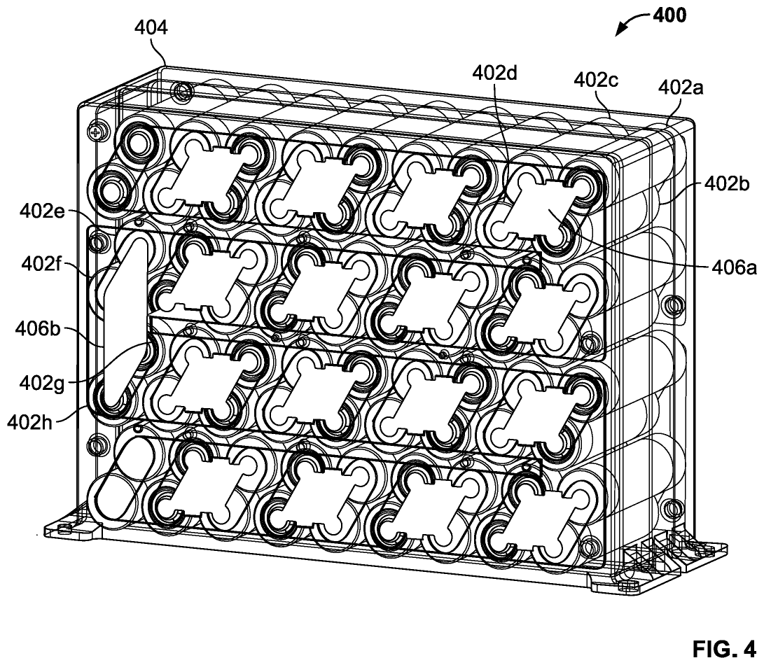

FIG. 4 is a diagram illustrating an embodiment of a battery system with 72 cylindrical cells in a case. In this example, the cylindrical cells (e.g., 402a-402h) of the battery system (400) are enclosed on all sides by a six-sided case (404). In this example, the battery system (400) has 72 cylindrical cells arranged in a 2-in-parallel, 36-in-series (2p36s) configuration. That is, the cylindrical cells are first connected in parallel in groups of two. Then, the 36 groups of two-in-parallel cylindrical cells are connected together in series.

To minimize the dimensions of the electrical tabs and/or other wiring or connections (which is desirable), each electrical tab (e.g., 406a and 406b) connects cylindrical cells from multiple rows as well as multiple groups of two in-parallel cylindrical cells. To help keep the dimensions of the electrical tabs small, each cylindrical cell alternates direction (e.g., going from left to right along each row). As a result, exemplary electrical tab 406a is connected to the positive terminals of cylindrical cells 402a and 402b (which are in different rows) and the negative terminals of cylindrical cells 402c and 402d (which are also in different rows) where cylindrical cells 402a and 402b form one group of in-parallel cells and cylindrical cells 402c and 402d form another group of in-parallel cells.

In the case of electrical tab 406b, cylindrical cells from four different rows are connected. In that example, cylindrical cells 402e and 402f form one group of in-parallel cells and cylindrical cells 402g and 402h form another group of in-parallel cells.

Thus, each electrical tab (e.g., 406a and 406b) is used to create both an in-parallel connection (e.g., connecting one group's negative terminals to each other and the other group's positive terminals to each other) as well as an in-series connection (e.g., the connection between the first group's positive terminals and the other group's negative terminals). Compared to the example battery system (300) described in FIGS. 3A-3C, this may eliminate dangling wires or connectors and/or reduce the (total) length of connectors.

Whereas the battery system embodiment described in FIGS. 3A-3D is a drop-in replacement (e.g., with the same dimensions as the original battery system shown in FIG. 2 to avoid having to make changes to the internal connections within the float), this example (and the following examples) corresponds to later battery systems which are not required to be drop-in replacements. For example, to accommodate the additional row of cylindrical cells, battery system 400 shown in FIG. 4 is taller than battery system 300 in FIG. 3A or battery system 200 in FIG. 2.

Another difference is that electrically, battery system 400 has a higher voltage. For example, if a single cylindrical cell has a nominal voltage of 3.6V, then the total voltage produced by battery system 400 is 3.6 V×36=129.6 V, which is higher than battery system 300 in FIG. 3A. Correspondingly, the (total) current output by battery system 400 is lower than the output by battery system 300 in FIG. 3A. The lower current output by this battery system means that less heat is produced during flight, so the enclosed case shown here does not have a detrimental effect because less heat needs to be dissipated.

Returning briefly to the example vehicle shown in FIGS. 1A and 1B, in one example application, the vehicle is used in a fleet of on-demand personal transportation vehicles. In this example application, vehicles are able to fly autonomously and/or are piloted remotely so that the vehicle can fly without an occupant or if there is an occupant, the occupant does not need to pilot the vehicle. Passengers request a ride and one of the vehicles is dispatched to a pickup location where the passenger gets into the vehicle. The occupant would then be flown to a drop-off location. The vertical takeoff and landing capability and small footprint of the vehicle permit the vehicle to pick up and drop off passengers even in dense and/or urban locations. In various scenarios, the vehicle then waits at the drop-off location for a next ride, flies to some maintenance yard or depot for charging and/or to await for a next ride, etc.

In such an application (and even in other applications or usage scenarios), it is desirable if vehicle charging time could be reduced or otherwise improved. For a fleet of on-demand personal transportation vehicles, this would increase the duty cycle or up time of each vehicle and permit more people to be supported or flown given the same number of vehicles. Even for a single, dedicated user, faster charging times would be attractive, for example, for longer and/or intercity trips. With the battery embodiments described above, one limitation to improving charging time is that the batteries generate significant heat during flight that needs to be dissipated before charging can begin (i.e., the batteries need to be cooled to an acceptable charging temperature before charging can begin).

The solution to this (with the battery embodiments described above) is to open the access panels (e.g., 152a in FIG. 1A and 152b in FIG. 1B) after the vehicle has landed and insert a hose into the floats which blows cooled air over the batteries. Currently it takes ˜30 minutes to air cool the batteries with this technique. Once the batteries are sufficiently cool, charging begins. Currently it takes ˜80 minutes to fully charge a battery once cooling has completed for a total charging time of ˜110 minutes. Even with easy-to-implement and/or short-term improvements, those times are estimated to only come down to ˜10 minutes for cooling and ˜30 minutes for active charging for a total of ˜40 minutes. This is still a relatively long time and it would be desirable if this turnaround and/or down time could be further reduced. To that end, the following figures describe various embodiments of battery systems with features to make swapping batteries out of a vehicle faster than cooling and charging the batteries while in the float.

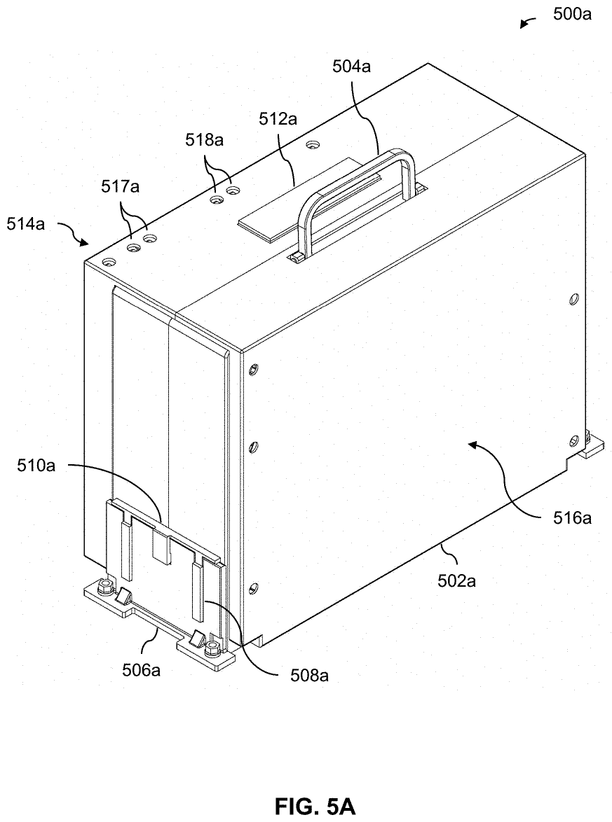

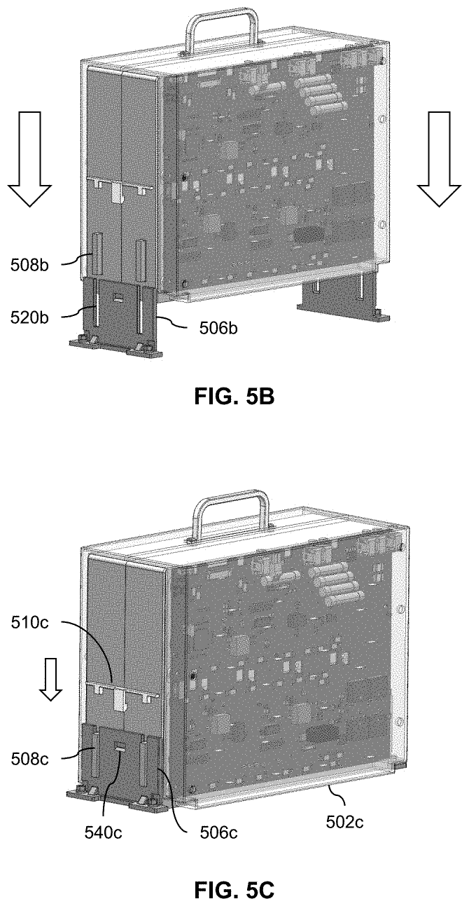

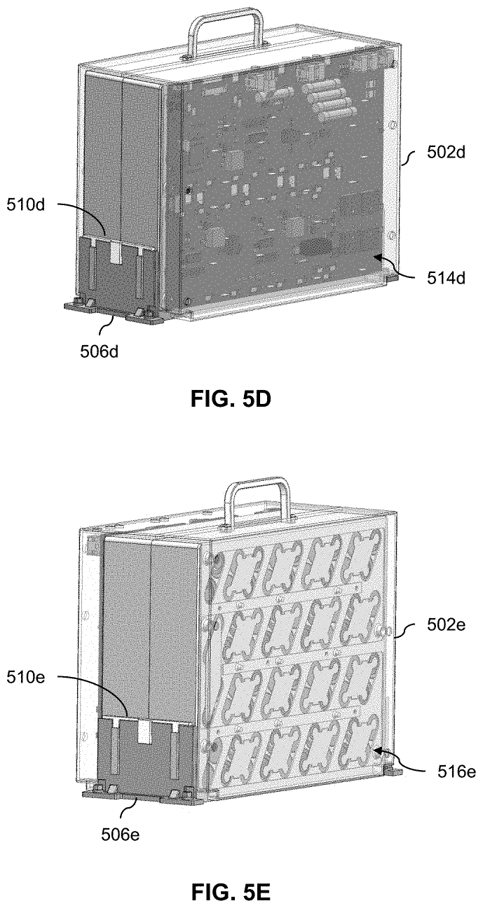

FIG. 5A is a diagram illustrating an embodiment of a swappable battery system with a handle and a display. In the example shown, the battery system (500a) includes cylindrical cells (not shown), various embodiments of which are described above. To protect the cylindrical cells and other internal components of the battery system from damage when inserted into or removed from a float, a hard case (502a) encloses the cylindrical battery cells (not shown) as well as a battery management system (not shown). In the battery system example described above that has a case (e.g., 400 in FIG. 4), the case (e.g., 404 in FIG. 4) enclosed the cylindrical cells (e.g., 402a-402h in FIG. 4) but not a printed circuit board (PCB) on which the battery management system is implemented (in FIG. 4 the PCB is not shown but it is outside of case 404). In contrast, in this example, the case (502a) encloses and protects the battery management system and/or PCB as well as the cylindrical cells. In some embodiments, the PCB may include other modules and/or features in addition to a battery management system.

In this application, the batteries are accessed from above because the access panels (e.g., 152a in FIG. 1A and 152b in FIG. 1B) are located at the top surface of the floats (e.g., 106a in FIG. 1A and 106b in FIG. 1B) to prevent water intrusion into the floats. As such, the handle (504a) is located on the top surface of the case.

The swappable battery system is held in place using slide-in brackets (506a) in the float, vertical guide rails (508a) on the exterior of the case (502a), and retaining clips (510a) which are separate from the slide-in brackets (506a) and case (502a) and are used to secure the case (502a) to the slide-in brackets (506a). (The following figures describe in more detail how these components are used to hold the swappable battery system in place.)

It is noted that the slide-in brackets (506a) and case (502a) have any asymmetry which may make it easier to distinguish which side of the case contains the battery management system and/or PCB if it is not apparent from a particular drawing. The cylindrical cells are much heavier than the battery management system and/or PCB and so to properly secure the heavier cylindrical cells, the slide-in brackets (506a) are aligned with and/or placed beneath the heavier cylindrical cells inside the case. As a result, the slide-in brackets (506a) on the heavier side of the case (516a), which in this view is facing the viewer and does not have the PCB, extend almost fully to the edge of the heavier side of the case (516a). In contrast, on the lighter side of the case (514a), which in this view is facing away from the viewer and has the PCB, the slide-in brackets (506a) do not extend fully to the lighter side (514a) and so the case appears to protrude more (e.g., from the slide-in brackets) on that side.

In this example, the battery system (500a) also includes a display (512a) which presents or otherwise displays information associated with the management, health, and/or state of the battery system. Older versions of the battery system did not have a display. To make the display easily visible when the swappable battery system is in the float, the display is located on the top surface of the case. Naturally, the display may be used when the battery is outside of the float (e.g., on a charging rack being charged, after charging while awaiting insertion into a float, etc.). In this example, the display is coupled to a battery management system in the case which collects, measures, and/or generates information about the battery. Some examples of information from the battery management system which is displayed by display (512a) include battery charge (e.g., percent charged), battery temperature, error codes from the most recent flight. This information may, for example, let a technician know which batteries are near or at end-of-life, which ones are fully charged, which ones are sufficiently cooled (e.g., for performance and/or to extend the lifetime of the battery it may be desirable to swap in batteries that are at or below some desired temperature), etc.

The top of the case also includes screw terminals (e.g., positive terminals 517a and negative terminals 518a) to electrically connect the power supply from the battery to the vehicle. For example, a float may include 5 power cables, one for each of the batteries in that float. The ends of the power cables may be inserted into and/or otherwise coupled to screw terminals (517a and 518a) to supply power from that battery to the vehicle. Naturally, in some other embodiments, other types of interfaces and/or connectors may be used. Other screw terminals may be associated with other signals (e.g., control signals to the battery management system from the flight controller, data signals from the battery management system to the flight controller, etc.).

The following figures show how the exemplary battery system shown here (500a) is inserted or otherwise connected to the vehicle.

FIG. 5B is a diagram illustrating an embodiment of insertion of a swappable battery system at a first point in time. For convenience, some features shown in FIG. 5A (e.g., display 512a) are not shown here. In this example, two slide-in brackets (506b) are bolted to a shelf (not shown) in the vehicle's float which supports the batteries in that float. The sides of the case that come into contact with the slide-in bracket have two protruding and vertical guide rails (508b) which slide into corresponding vertical cutouts or openings (520b) in the slide-in bracket.

FIG. 5C is a diagram illustrating an embodiment of insertion of a swappable battery system at a second point in time. Once the swappable battery system is fully inserted into the slide-in brackets (506c) as shown here, the retaining clips (510c) are inserted into the slide-in brackets (506c). The retaining clips (510c) have two vertical guide rails that rest above the corresponding guide rails (508c) of the battery when both are in the slide-in brackets (506c). In the center of the retaining clips (510c) is a snap-in clip that fits into a corresponding hole (540c) in the slide-in brackets (506c). The retaining clips (510c), for example, prevent the case (502c) (or, more specifically, the guide rails (508c)) from lifting up and out of the slide-in brackets (506c), for example, if the vehicle were to suddenly drop and the battery tried to lift up out of the slide-in brackets (506c).

FIG. 5D is a diagram illustrating an embodiment of insertion of a swappable battery system at a third point in time from a first view. In the state shown here, the case (502d) is secured to the vehicle using the slide-in brackets (506d) and retaining clips (510d). In this view, the side of the case with the PCB and/or battery management system (514d) is facing the viewer.

FIG. 5E is a diagram illustrating an embodiment of insertion of a swappable battery system at a third point in time from a second view. In the state shown here, the case (502e) is secured to the vehicle using the slide-in brackets (506e) and retaining clips (510e). In this view, the side of the case that does not have the PCB and/or battery management system (516e) is facing the viewer.

As described above, even with improvements, it is estimated that it will take ˜40 minutes to cool and charge a battery if the battery were to remain within the float when charged on the ground. With the swappable battery system example described above, it is possible for all 10 of the batteries to be swapped out for fully charged batteries in less time than it would take to cool and charge the batteries in the float, even with improvements (e.g., less than ˜40 minutes). As described above, for applications in which the vehicle is part of a fleet of autonomous vehicles to transport people (and even applications where a single user owns or uses a given vehicle), it is desirable to reduce down time.

Another benefit is that the features shown here which make it easier to swap batteries in and out may also lighter, less expensive, and/or less complex than components or structures that would be required (as an example) to support liquid cooling of batteries. For example, it would require ˜20 lbs. of dielectric oil to cool 10 batteries and with an ultralight vehicle this is a significant increase in weight.

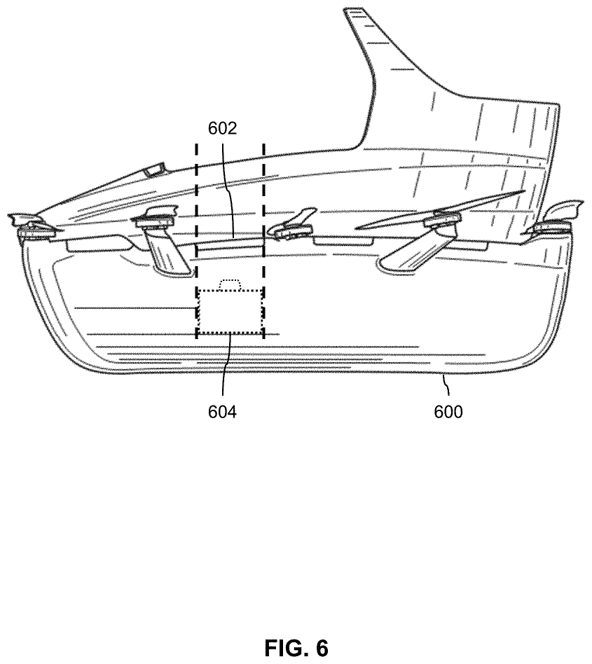

FIG. 6 is a diagram illustrating an embodiment of a vehicle with a battery positioned beneath an access panel in a float. In various embodiments, a variety of changes may be made to a float (600) and/or an access panel (602) to make it easier to swap a battery (e.g., 604) in and out of the float. In this example, the exemplary battery shown has been (re)positioned to be directly beneath an access panel (602). In some embodiments, an access panel is widened and/or enlarged (e.g., to make it easier to access two batteries beneath that access panel). In some embodiments, a fourth or even a fifth access panel is added to the float. In some embodiments, access panels are added to some other surface of the float (e.g., the outward-facing side of the float for one of the inner batteries or the front or aft sides of the float in order to access the frontmost or aftmost batteries, respectively).

In some embodiments, the access panels (e.g., 602) on the top of the float double as the lid or handle for each swappable battery pack. For example, a technician would first unlock or otherwise unlatch the access panel by inserting and turning a key or lever which relieves the downward pressure on the panel against the float and then electrically and physically decouple the swappable battery pack from the vehicle by pulling straight up on a handle that would be on the top of the access panel so that there is no need to remove wires in this case. Once the appropriate locks, latches, and/or connectors have been unlocked or released, a technician grabs a handle (not shown) on the access panel and removes the battery, as well as the access panel. A fully charged battery with its attached access panel is then inserted into the float.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A battery system, comprising:
a first end plate including a plurality of cutouts;
a plurality of cylindrical cells, including a first cylindrical cell and a second cylindrical cell;
an electrical tab fitting entirely within a cutout of the plurality of cutouts wherein the cutout is a single cutout, wherein the cutout exposes one terminal end of the first cylindrical cell and one terminal end of the second cylindrical cell, and wherein the electrical tab is connected to the first cylindrical cell and the second cylindrical cell using spot welding; and
a battery management printed circuit board, wherein the electrical tab provides a connecting surface for a battery management signal between (1) the first cylindrical cell and the second cylindrical cell and (2) the battery management printed circuit board.

2. The battery system recited in claim 1 further comprising a second end plate, wherein:
the cutout is configured to hold the one terminal end of the first cylindrical cell and the one terminal end of the second cylindrical cell; and
the second end plate includes a plurality of cutouts configured to hold another terminal end of the first cylindrical cell and another terminal end of the second cylindrical cell.

3. The battery system recited in claim 1 further comprising a second end plate, wherein:
the cutout is configured to hold the one terminal end of the first cylindrical cell and the one terminal end of the second cylindrical cell;
the second end plate includes a plurality of cutouts configured to hold another terminal end of the first cylindrical cell and another terminal end of the second cylindrical cell; and
the battery system is exposed on four sides other than a first side associated with the first end plate and a second side associated with the second end plate.

4. The battery system recited in claim 1, wherein the plurality of cylindrical cells is electrically connected in a plurality of three-in-parallel groups.

5. The battery system recited in claim 1, wherein the plurality of cylindrical cells is electrically connected in a 3-in-parallel, 21-in-series connection.

6. The battery system recited in claim 1 further comprising a third cylindrical cell and a fourth cylindrical cell, wherein:
the first cylindrical cell and the second cylindrical cell are in a first group of in-parallel cells;
the third cylindrical cell and the fourth cylindrical cell are in a second group of in-parallel cells; and
the electrical tab connects: (1) the first cylindrical cell and the second cylindrical cell in parallel, (2) the third cylindrical cell and the fourth cylindrical cell in parallel, and (3) the first group of in-parallel cells and the second group of in-parallel cells in series.

7. The battery system recited in claim 1 further comprising a third cylindrical cell and a fourth cylindrical cell, wherein:
the first cylindrical cell and the second cylindrical cell are in a first group of in-parallel cells;
the third cylindrical cell and the fourth cylindrical cell are in a second group of in-parallel cells;
the electrical tab connects: (1) the first cylindrical cell and the second cylindrical cell in parallel, (2) the third cylindrical cell and the fourth cylindrical cell in parallel, and (3) the first group of in-parallel cells and the second group of in-parallel cells in series;
the first cylindrical cell and the third cylindrical cell are in a first row of cells; and
the second cylindrical cell and the fourth cylindrical cell are in a second row of cells.

8. The battery system recited in claim 1 further comprising a third cylindrical cell and a fourth cylindrical cell, wherein:
the first cylindrical cell and the second cylindrical cell are in a first group of in-parallel cells;
the third cylindrical cell and the fourth cylindrical cell are in a second group of in-parallel cells;
the electrical tab connects: (1) the first cylindrical cell and the second cylindrical cell in parallel, (2) the third cylindrical cell and the fourth cylindrical cell in parallel, and (3) the first group of in-parallel cells and the second group of in-parallel cells in series; and
the first cylindrical cell, the second cylindrical cell, the third cylindrical cell, and the fourth cylindrical cell are in a first row of cells, a second row of cells, a third row of cells, and a fourth row of cells, respectively.

9. The battery system recited in claim 1, wherein the plurality of cylindrical cells is electrically connected in a plurality of two-in-parallel groups.

10. The battery system recited in claim 1, wherein the plurality of cylindrical cells is electrically connected in a 2-in-parallel, 36-in-series connection.

11. The battery system recited in claim 1 further comprising a case with a handle and one or more vertical guide rails, wherein the battery system is configured to be vertically lowered into one or more slide-in brackets.

12. The battery system recited in claim 1 further comprising:
a case with a handle and one or more vertical guide rails, wherein the battery system is configured to be vertically lowered into one or more slide-in brackets;
a battery management system inside the case; and
a display disposed on a top surface of the case, wherein the display is configured to display information from the battery management system.

13. A method, comprising:
providing a first end plate including a plurality of cutouts;
providing a plurality of cylindrical cells, including a first cylindrical cell and a second cylindrical cell;
providing an electrical tab fitting entirely within a cutout of the plurality of cutouts, wherein the cutout is a single cutout, wherein the cutout exposes one terminal end of the first cylindrical cell and one terminal end of the second cylindrical cell, and wherein the electrical tab is connected to the first cylindrical cell and the second cylindrical cell using spot welding; and
providing a battery management printed circuit board, wherein the electrical tab provides a connecting surface for a battery management signal between (1) the first cylindrical cell and the second cylindrical cell and (2) the battery management printed circuit board.

14. The method recited in claim 13 further comprising providing a second end plate, wherein:
the cutout is configured to hold the one terminal end of the first cylindrical cell and the one terminal end of the second cylindrical cell; and
the second end plate includes a plurality of cutouts configured to hold a another terminal end of the first cylindrical cell and another terminal end of the second cylindrical cell.

15. The method recited in claim 13 further comprising providing a second end plate, wherein:
the cutout is configured to hold the one terminal end of the first cylindrical cell and the one terminal end of the second cylindrical cell;
the second end plate includes a plurality of cutouts configured to hold another terminal end of the first cylindrical cell and another terminal end of the second cylindrical cell; and
a battery system, which includes the plurality of cylindrical cells, the electrical tab, the battery management printed circuit board, the first end plate, and the second end plate, is exposed on four sides other than a first side associated with the first end plate and a second side associated with the second end plate.

16. The method recited in claim 13 further comprising providing a third cylindrical cell and a fourth cylindrical cell, wherein:
the first cylindrical cell and the second cylindrical cell are in a first group of in-parallel cells;
the third cylindrical cell and the fourth cylindrical cell are in a second group of in-parallel cells; and
the electrical tab connects: (1) the first cylindrical cell and the second cylindrical cell in parallel, (2) the third cylindrical cell and the fourth cylindrical cell in parallel, and (3) the first group of in-parallel cells and the second group of in-parallel cells in series.

17. The method recited in claim 13 further comprising providing a third cylindrical cell and a fourth cylindrical cell, wherein:
the first cylindrical cell and the second cylindrical cell are in a first group of in-parallel cells;
the third cylindrical cell and the fourth cylindrical cell are in a second group of in-parallel cells;
the electrical tab connects: (1) the first cylindrical cell and the second cylindrical cell in parallel, (2) the third cylindrical cell and the fourth cylindrical cell in parallel, and (3) the first group of in-parallel cells and the second group of in-parallel cells in series;
the first cylindrical cell and the third cylindrical cell are in a first row of cells; and
the second cylindrical cell and the fourth cylindrical cell are in a second row of cells.

18. The method recited in claim 13 further comprising providing a third cylindrical cell and a fourth cylindrical cell, wherein:
the first cylindrical cell and the second cylindrical cell are in a first group of in-parallel cells;
the third cylindrical cell and the fourth cylindrical cell are in a second group of in-parallel cells;
the electrical tab connects: (1) the first cylindrical cell and the second cylindrical cell in parallel, (2) the third cylindrical cell and the fourth cylindrical cell in parallel, and (3) the first group of in-parallel cells and the second group of in-parallel cells in series; and
the first cylindrical cell, the second cylindrical cell, the third cylindrical cell, and the fourth cylindrical cell are in a first row of cells, a second row of cells, a third row of cells, and a fourth row of cells, respectively.

19. The method recited in claim 13 further comprising providing a case with a handle and one or more vertical guide rails, wherein a battery system, which includes the plurality of cylindrical cells, the electrical tab, the battery management printed circuit board, and the case, is configured to be vertically lowered into one or more slide-in brackets.

20. The method recited in claim 13 further comprising:
providing a case with a handle and one or more vertical guide rails, wherein a battery system, which includes the plurality of cylindrical cells, the electrical tab, the battery management printed circuit board, and the case, is configured to be vertically lowered into one or more slide-in brackets;
providing a battery management system inside the case; and
providing a display disposed on a top surface of the case, wherein the display is configured to display information from the battery management system.

21. (canceled)
